(19) United States
(12) Patent Application Publication
(10) Pub. No.: US 2009/0092205 A1
(43) Pub. Date: Apr. 9, 2009

(54) TABLE DATA GENERATION DEVICE AND METHOD

(75) Inventor: Shigeru Amano, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 12/211,121

(22) Filed: Sep. 16, 2008

(30) Foreign Application Priority Data
Oct. 5, 2007 (JP) 2007262090

(51) Int. Cl. H04L 27/06

(52) U.S. Cl. 375/340

(57) ABSTRACT

A table data generation device includes: a setting data storage section that stores setting data of a receiver for receiving broadcast waves; a bit width specification section that specifies a bit width from a reference position of the setting data; a number-of-shifts specification section that specifies a number of shifts of the setting data; and a table data generator that generates table data for the setting data by shifting the specified bit width of the setting data by the specified number of shifts.

### CROSS-REFERENCE TO RELATED APPLICATION

This application claims priority under 35 USC 119 from Japanese Patent Application No. 2007-262090, the disclosure of which is incorporated by reference herein.

### BACKGROUND OF THE INVENTION

1. Field of the Invention

The present invention relates to a table data generation device and a table data generation method.

2. Description of the Related Art

Digital terrestrial broadcast channel detecting devices include a function called broadcast wave scanning for searching for broadcasts in the places where the devices operate. This broadcast wave scanning function is a function which, in the case of digital television broadcasting, for example, determines whether or not broadcasting is being performed on channels 13 to 62 of the UHF band and performs correspondence between a remote control number and broadcast parameters such as the physical frequency thereof. This is referred as initial scanning or re-scanning and is defined in the technical documents “Operational Guideline of Digital Audio Broadcasting” and “Operational Guideline of Digital Terrestrial Television Broadcasting” (Association of Radio Industries and Broadcast (ARIB) TR-B13 and 14).

However, when a user actually uses the broadcast wave scanning function, the broadcast wave scanning will take time in units of several tens of seconds. It suffices for stationary television devices that are used in homes to execute the broadcast wave scanning once, so this execution time is acceptable. However, when mobile devices including mobile telephones are equipped with the broadcast wave scanning function, this execution time will not be acceptable because the devices frequently move.

For this reason, rather than a CPU (software) searching one channel at a time, a receiver (a tuner LSI and an Orthogonal Frequency Division Multiplexing (OFDM) demodulation LSI) performs this operation autonomously by hardware and significantly shortens the amount of time. (Hereinafter, this mechanism will be called “auto scanning”.)

Conventionally, tuner LSIs and OFDM demodulation LSIs are separate, and both of them are provided by many manufacturers.

In auto scanning, a controller inside an OFDM demodulation LSI receives an auto scanning request from a CPU and the controller performs auto scanning while switching between the channels that are received by autonomously rewriting a setting of a register that is related to a frequency setting inside a tuner LSI.

At this time, it is necessary for the OFDM demodulation LSI to have register information inside that is related to the frequency setting in order to autonomously rewrite the reception frequency of the tuner LSI. Thus, OFDM demodulation LSIs have not been able to control tuner LSIs whose register maps are different, such as non-adapting (compatible) tuner LSIs, and have not been able to provide the auto scanning function with respect to new tuner LSIs.

Japanese Patent Application (JP-A) No. 2004-179928 discloses a digital broadcast receiver which, when the reception environment is not stable, stores digital broadcast channels in a channel list. Further, JP-A No. 2005-333190 discloses a digital channel searching method that performs, at a high speed, channel scanning of broadcasts for which channel scanning is necessary, as in digital terrestrial broadcasting, in an environment where plural types of digital broadcasts are being transmitted in the same modulation system, as in digital broadcast retransmission in cable television (CATV).

However, in JP-A No. 2004-179928, although a controller 8 that selects and controls a known tuner 2 is disclosed as shown in FIG. 2 of the same document, it is silent in regard to how to select and control the tuner 2 when the tuner 2 is unknown. Similarly, in JP-A No. 2005-333190, although a controller 106 that selects and controls a known tuner 101 is disclosed, it is silent in regard to how to select and control the tuner 101 when the tuner 101 is unknown. That is, conventionally, appropriate table data cannot be used in regard to unknown tuners and auto scanning cannot be executed.

### SUMMARY OF THE INVENTION

The present invention has been provided in order to address the aforementioned problems and provides a table data generation device and method that can generate table data for controlling an unknown receiver.

A first aspect of the present invention is a table data generation device including: a setting data storage section that stores setting data of a receiver for receiving broadcast waves; a bit width specification section that specifies a bit width from a reference position of the setting data; a number-of-shifts specification section that specifies a number of shifts of the setting data; and a table data generator that generates table data for the setting data by shifting the specified bit width of the setting data by the specified number of shifts.

In the first aspect, the setting data storage section may store setting data that has been generated inside the table data generation device or setting data that has been generated by an external device which is different from the table data generation device.

In the first aspect, the setting data storage section may store plural sets of the setting data, and the table data generator may generate table data for each of the sets of setting data by shifting the specified bit width by the specified number of shifts.

In the first aspect, the table data generator may use plural associated elements as one set of setting data, and may generate table data for each of the associated elements by shifting the specified bit width by the specified number of shifts.

A second aspect of the present invention is a table data generation device method including: storing setting data of a receiver for receiving broadcast waves; specifying a bit width from a reference position of the setting data and specifying a number of shifts of the setting data; and generating table data for the setting data by reading the setting data and shifting the specified bit width of the setting data by the specified number of shifts.

In the second aspect, the method may executed in a device that comprises a storage section that stores setting data, and the stored setting data may be generated inside the device or by an external device which is different from the device.

In the second aspect, the storing may include storing plural sets of the setting data, and the generating may include generating table data for each of the sets of the setting data by shifting the specified bit width by the specified number of shifts.

In the second aspect, the generating may include using a plurality of associated elements as one set of setting data, and generating table data for each of the associated elements by shifting the specified bit width by the specified number of shifts.

### BRIEF DESCRIPTION OF THE DRAWINGS

Exemplary embodiments of the present invention will be described in detail based on the following figures, wherein:

FIG. 1 is a block diagram showing a configuration of a digital broadcast receiver pertaining to a first exemplary embodiment of the present invention;

FIG. 2 is a block diagram showing a configuration of a table generator 25a;

FIG. 3 is a configural diagram of sets of setting data 1 and 2;

FIG. 4 is a diagram for describing table generation process for the set of setting data 1;

FIG. 5 is a diagram for describing table data (output data) that is generated from the sets of setting data 1 and 2;

FIG. 6 is a diagram showing the table data that has been generated being delimited in byte units and outputted;

FIG. 7 is a block diagram showing the configuration of a digital broadcast receiver that includes table data 25b;

FIG. 8 is a diagram showing the configuration of sets of setting data 1 and 2 in a second exemplary embodiment;

FIG. 9 is a diagram showing the configuration of the sets of setting data 1 and 2 in the second exemplary embodiment;

FIG. 10 is a diagram for describing table generation process for the set of setting data 2;

FIG. 11 is a diagram for describing table data (output data) that is generated from the sets of setting data 1 and 2 that have been integrated;

FIG. 12 is a diagram showing the configuration of a digital broadcast receiver;

FIG. 13 is a flowchart showing a first channel detection routine;

FIG. 14 is a flowchart showing a second channel detection routine;

FIG. 15 is a diagram showing the configuration of a digital broadcast receiver that includes a broadcast station information table 50; and

FIG. 16 is a flowchart showing a third channel detection routine.

### DETAILED DESCRIPTION OF THE INVENTION

### First Exemplary Embodiment

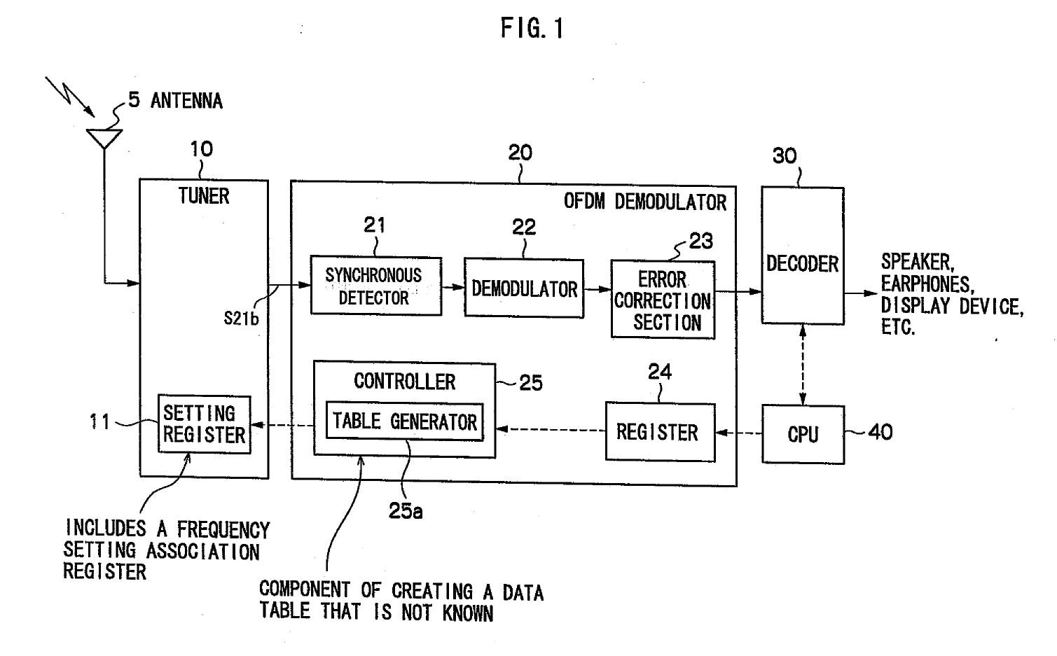

FIG. 1 is a block diagram showing the configuration of a digital broadcast receiver pertaining to a first exemplary embodiment of the present invention. The digital broadcast receiver includes a tuner LSI 10 (below, simply called “the tuner 10”) that receives digital broadcast waves (below, simply called “digital broadcast waves”) via an antenna 5, an Orthogonal Frequency Division Multiplexing (OFDM) demodulator 20 that demodulates the broadcast waves that have been received, a decoder 30 that decodes the signals that have been demodulated, and a CPU 40 that controls the OFDM demodulator 20.

The tuner 10 selects a channel of a predetermined frequency band with respect to the broadcast waves, tunes in, and outputs a baseband signal S21b. Further, the tuner 10 includes a setting register 11 that is a register associated with the frequency setting of the broadcast waves. The setting register 11 stores data for setting a Phase Locked Loop (PLL) and data for selecting and setting a Voltage Controlled Oscillator (VCO), for example.

The OFDM demodulator 20 includes a synchronous detector 21 that performs establishment of synchronization on the baseband signal from the tuner 10, outputs a synchronized playback signal and outputs a synchronization establishment signal, a demodulator 22 that performs high-speed Fourier transformation on the synchronized playback signal and outputs a demodulation signal, an error correction section 23 that corrects errors in the demodulation signal, performs deinterleave processing and outputs a Transport Stream (TS) signal, a register 24 that stores a bit width and a number of shifts, and a controller 25 that generates a setting table.

The controller 25 includes a table generator 25a for generating table data that corresponds to the setting register 11 of the tuner 10 that is not known.

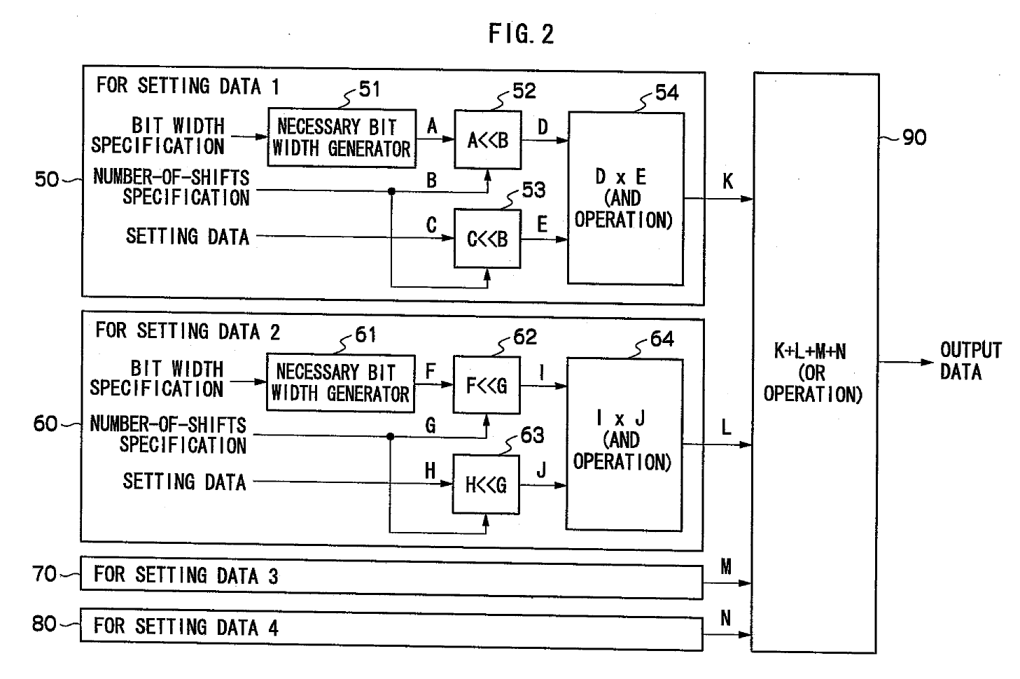

FIG. 2 is a block diagram showing a configuration of the table generator 25a. The table generator 25a includes operators 50, 60, 70 and 80 for operating sets of setting data 1 to 4 and an OR operator 90 that performs logical OR operation on and outputs the operational results of these.

The operator 50 includes a necessary bit width generation circuit 51 that generates a necessary bit width, a bit width shifting circuit 52 that shifts the bit width, a setting data shifting circuit 53 that shifts the setting data, and an AND operator 54 that performs AND operation of the output results of the bit width shifting circuit 52 and the setting data shifting circuit 53.

The operator 60 includes a necessary bit width generation circuit 61 that generates a necessary bit width, a bit width shifting circuit 62 that shifts the bit width, a setting data shifting circuit 63 that shifts the setting data, and an AND operator 64 that performs AND operation of the output results of the bit width shifting circuit 62 and the setting data shifting circuit 63. It will be noted that the operators 70 and 80 are configured in the same manner as the operators 50 and 60.

Each of the sets of setting data is stored in advance in the table generator 25a as fixed data, but its bit width may be specified and it may be set in a position shifted from a certain bit position (in the present exemplary embodiment, an Least Significant Bit (LSB)) as needed.

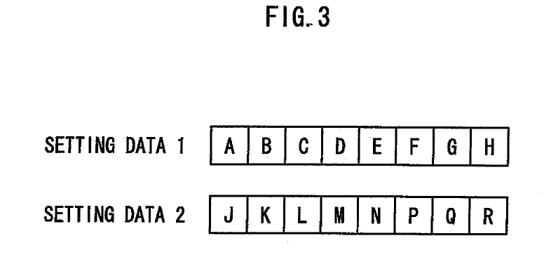

FIG. 3 is a diagram showing configurations of the sets of setting data 1 and 2. As shown FIG. 3, the set of setting data 1 corresponds to {A, B, C, D, E, F, G, H}, and the set of setting data 2 corresponds to {J, K, L, M, N, P, Q, R}. Here, each of the sets of setting data is 8 bits, but the number of bits is not particularly limited. Further, in the present exemplary embodiment, the sets of setting data are generated inside the table generator 25a, but this is not a limitation and they may also be generated outside (in an external device).

The digital broadcast receiver that is configured as described above generates table data by performing the following processing. Here, an example will be described where the bit width is set to 2 and the shift position from the LSB is set to 3 for the set of setting data 1, and the bit width is set to 5 and the shift position from the LSB is set to 9 for the set of setting data 2.

The CPU 40 sets the bit width and the number of shifts in the register 24 of the OFDM demodulator 20, and these values are supplied to the controller 25. Then, the table generator 25a of the controller 25 generates table data in the following manner.

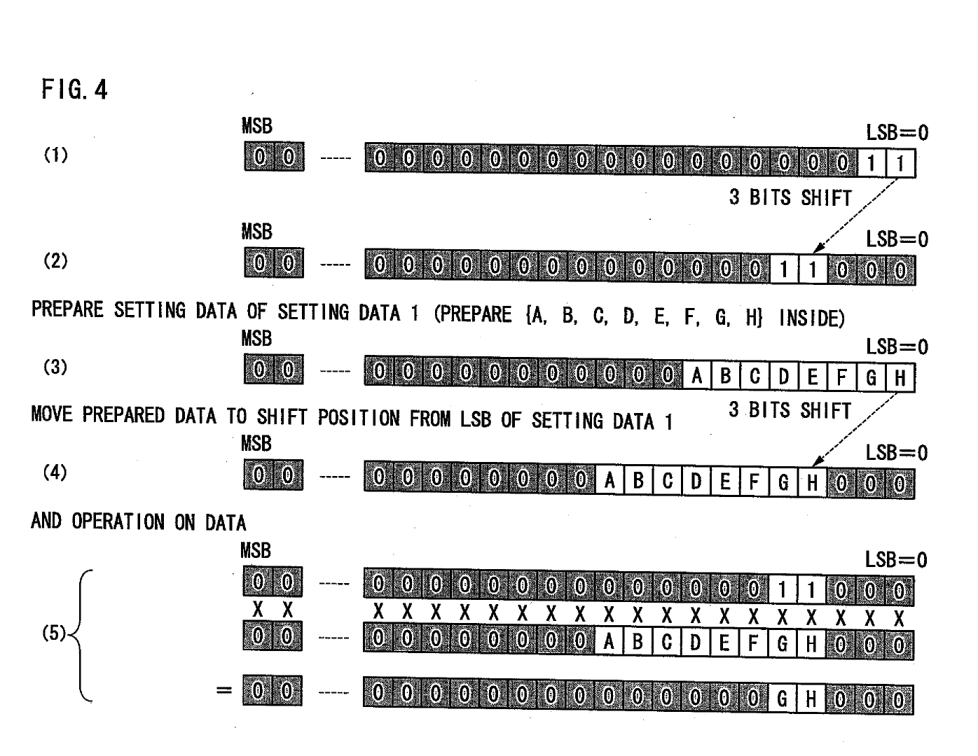

FIG. 4 is a diagram for describing table generation for the set of setting data 1.

As shown in (1) of FIG. 4, the necessary bit width generation circuit 51 of the table generator 25a generates, as preparation with respect to bit width=2 of the set of setting data 1, data of “1” for selected bit width that is equal to the specified bit width (the bit width that has been read from the register 24). Thus, the necessary bit width generation circuit 51 generates “11” that is equal to 2 bits width from the LSB. It will be noted that “0” is allocated for bits other than the bits for which “1” has been generated.

As shown in (2) of FIG. 4, the bit width shifting circuit 52 shifts “11” of the selected bit width that has been generated by the necessary bit width generation circuit 51 by the specified number of shifts (the number of shifts that has been read from the register 24) from the LSB of the set of setting data 1.

Next, as shown in (3) of FIG. 4, the controller 25 prepares the set of setting data {A, B, C, D, E, F, G, H} inside the table generator 25a. Here, an example will be described where the result that has been calculated inside the table generator 25a is output to a specified position. Since it is not always the case that all of the bits of the calculated setting data are outputted, bit width specification is performed in the necessary bit width generation circuit 51 as described above.

As shown in (4) of FIG. 4, the setting data shifting circuit 53 shifts the set of setting data, by the specified number of shifts (the number of shifts that has been read from the register 24), to a bit position where the prepared setting data is actually output.

As shown in (5) of FIG. 4, the AND operator 54 performs AND operation on the output results of the bit width shifting circuit 52 and the setting data shifting circuit 53 and completes table generation processing for this set of setting data.

Further, the operator 60 can, in the same manner as the operator 50, set the bit width to 5 and the shift position from the LSB to 9 for the set of setting data 2. Further, the operator 70 is capable of operation for the set of setting data 3, and the operator 80 is capable of operation for the set of setting data 4 respectively in a same manner as the operator 50, and therefore description of the settings for setting data 3 and 4 will be omitted. The OR operator 90 performs logical OR operation on the operation results of the operators 50, 60, 70 and 80 and outputs the result of the logical OR operation.

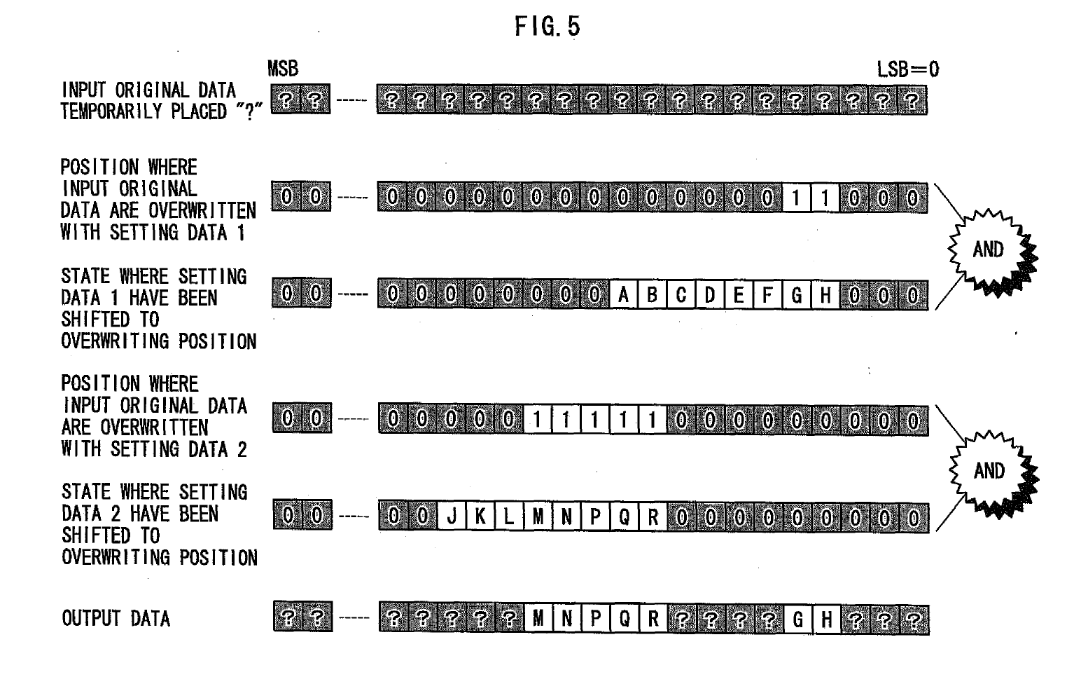

FIG. 5 is a diagram illustrating the table data (output data) that is generated from the sets of setting data 1 and 2. As shown in FIG. 5, GH, which is equal to 2 bits width of the set of setting data 1 that has been shifted 3 bits from the LSB, and MNPQR, which is equal to 5 bits width of the set of setting data 2 that has been shifted 9 bits from the LSB, are generated as the table data.

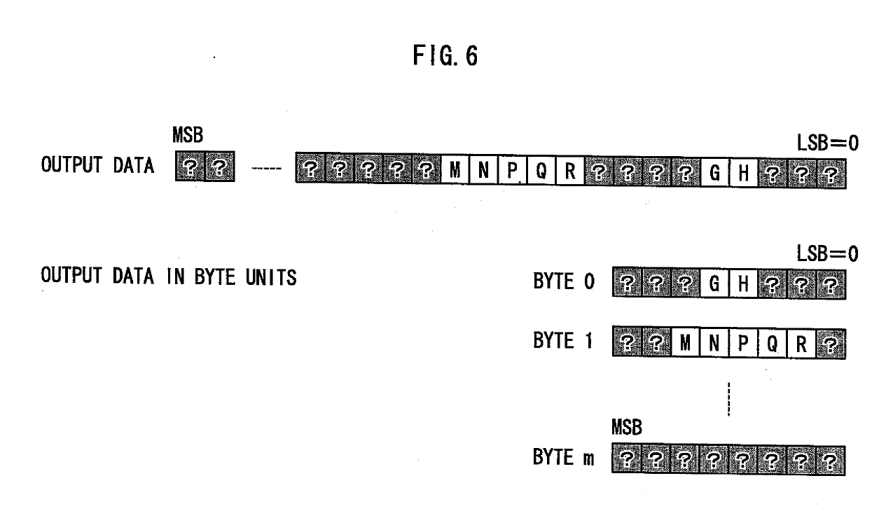

It will be noted that the digital broadcast receiver may also delimit the data in byte units when transferring setting data in byte units as many devices employ. FIG. 6 is a diagram showing the generated table data being delimited in byte units and outputted.

The table generator 25a can generate table data with respect to plural sets of setting data by performing the aforementioned steps by necessary elements. Plural sets of setting data are eventually obtained as a result of the OR operation of the OR operator 90 as described above.

Further, input original data that is original setting data is outputted as it is in regard to places (data portion) where there is no “1” that determines the selection position of each set of setting data. For this reason, by setting original setting data as fixed data, the data portions where there is no “1” can be output as fixed setting value portions.

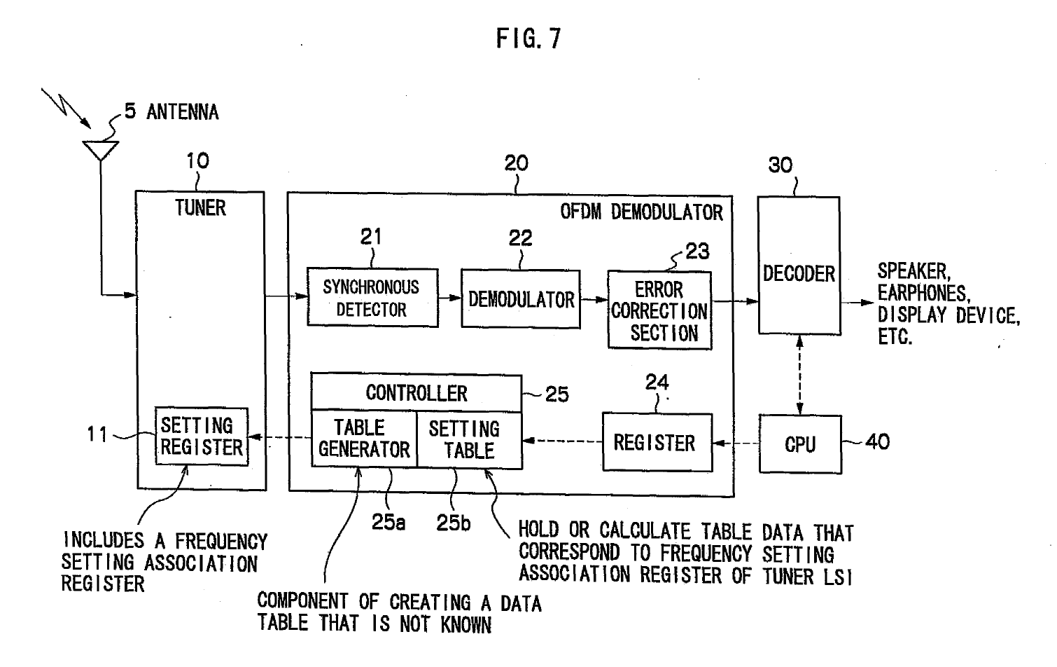

FIG. 7 is a block diagram showing a configuration of a digital broadcast receiver that includes setting table data 25b. As shown in FIG. 7, the control unit 25 includes the setting table data 25b that corresponds to the setting register 11 associated with the frequency setting of the tuner 10 and uses the setting table data to control the tuner 10.

As described above, even if the tuner 10 is not known, the digital broadcast receiver pertaining to the first exemplary embodiment of the present invention can create table data that corresponds to the tuner 10 that is not known.

Here, sets of the setting data that are necessary to the frequency setting association register in the tuner 10 are the same or extremely similar. Further, many sets of setting data that are set in the tuner 10 are not dependent on the frequency setting (CH) but take a fixed value in initial setting. The setting data are data for which it is necessary to rewrite the PLL setting of the tuner 10 or the VCO selection setting extent, for example, per frequency setting.

The digital broadcast receiver generates table data by specifying and shifting the bit width in regard to setting data that have been generated outside or inside. Therefore, it becomes unnecessary to prepare all setting data for all frequency settings from the outside as has conventionally been the case, and the circuit area can be significantly reduced. Further, there are the great advantages that the amount of data in the CPU 40 can be reduced and the computational load is reduced. Moreover, the amount of time for setting all setting data by the CPU 40 can be greatly reduced, which is also effective from the standpoints of operating time and complication.

### Second Exemplary Embodiment

Next, a second exemplary embodiment of the present invention will be described. It will be noted that the same reference numerals will be given to parts that are the same as those of the first exemplary embodiment and descriptions therefor are omitted, and that the points that are different will be mainly described.

A digital broadcast receiver pertaining to the second exemplary embodiment is configured as shown in FIG. 1 and FIG. 2. Whereas each of the sets of setting data had been completely independent in the first exemplary embodiment, here, in the second exemplary embodiment, a method of combining and processing the set of setting data 1 and the set of setting data 2 at once will be described.

The second exemplary embodiment can be used in a case in which the setting data actually used are in a relationship of a swallow counter and a program counter of PLL setting data or a relationship such as selection of a VCO itself in VCO selection and selection of a sub-band thereof and the number of bits of each set of the setting data are not fixed depending to their specifications or retrieval bit positions of calculation results differ.

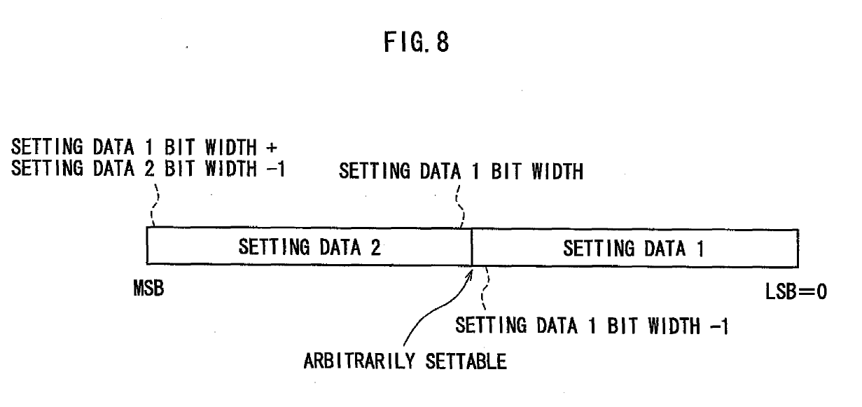

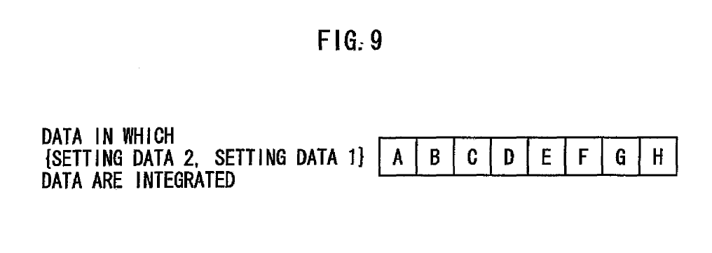

FIG. 8 and FIG. 9 are diagrams showing the configuration of sets of setting data 1 and 2 in the second exemplary embodiment. As for {setting data 2, setting data 1} in which the sets of setting data 1 and 2 are integrated, when, for example, the bit width of the set of setting data 1 increases by 1, the bit width of the set of setting data 2 decreases by 1. Further, similar to the first exemplary embodiment, {setting data 2, setting data 1} corresponds to {A, B, C, D, E, F, G, H} and is not limited to 8 bits.

Similar to the first exemplary embodiment, the bit width of each of the sets of setting data is specified and the shift position of each of the sets of setting data from a certain bit position (in the present exemplary embodiment, the LSB) is specified.

The digital broadcast receiver that is configured as described above generates table data by performing the following processing. Here, an example will be described where the bit width is set to 2 and the shift position from the LSB is set to 3 for the set of setting data 1, and the bit width is set to 3 and the shift position from the LSB is set to 9 for to the set of setting data 2.

The CPU 40 shown in FIG. 1 sets the bit width and the number of shifts in the register 24 of the OFDM demodulator 20, and these values are supplied to the controller 25. Then, the table generator 25a of the controller 25 generates table data in the following manner.

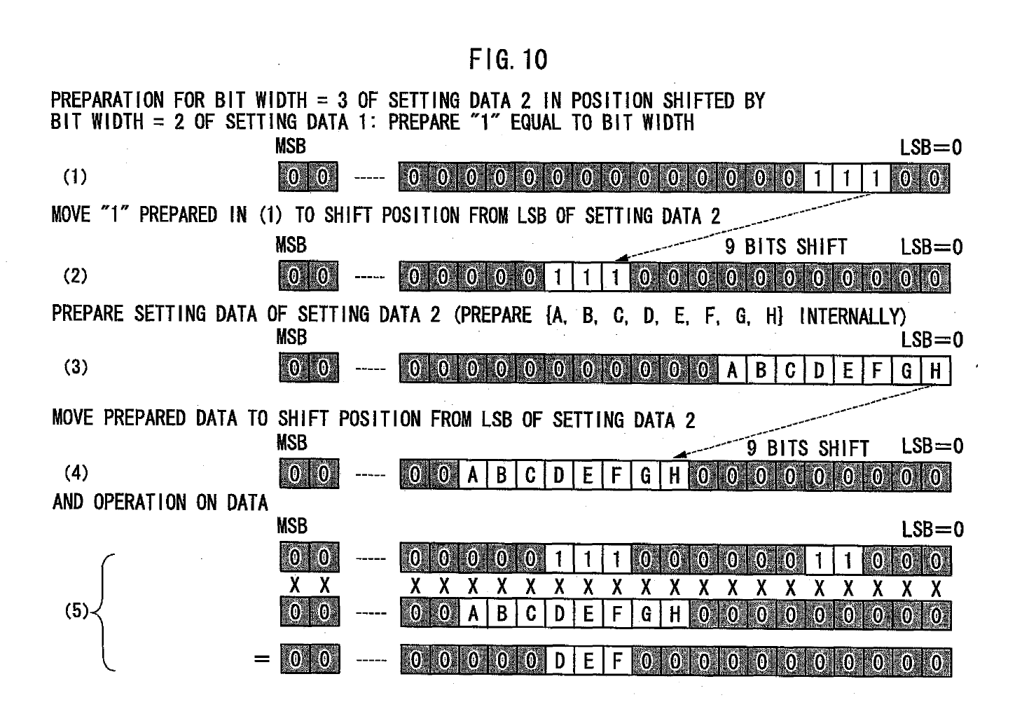

FIG. 10 is a diagram for describing table generation for the set of setting data 2.

As shown in (1) of FIG. 10, the necessary bit width generation circuit 51 of the table generator 25a generates, as preparation with respect to bit width=3 of the set of setting data 2 in a position shifted by bit width=2 of the set of setting data 1, data of “1” for selected bit width that is equal to the specified bit width. (the bit width that has been read from the register 24). Thus, the necessary bit width generation circuit 51 generates “111” that is equal to 3 bits width in a position shifted 2 bits from the LSB. It will be noted that “0” is allocated for bits other than the bits for which “1” has been generated.

As shown in (2) of FIG. 10, the bit width shifting circuit 52 shifts “111” of the selected bit width that has been generated by the necessary bit width generation circuit 51 by the specified number of shifts (the number of shifts that has been read from the register 24) from the LSB of the set of setting data 2.

Next, as shown in (3) of FIG. 10, the digital broadcast receiver prepares the set of setting data {A, B, C, D, E, F, G, H} inside the table generator 25a. Here, an example will be described where the result that has been calculated inside the table generator 25a is output to a specified position. Since it is not always the case that all of the bits of the calculated setting data are outputted, bit width specification is performed in the necessary bit width generation circuit 51 as described above.

As shown in (4) of FIG. 10, the setting data shifting circuit 53 shifts the set of setting data, by the specified number of shifts (the number of shifts that has been read from the register 24) from the LSB of the set of setting data 2, to a bit position where the prepared setting data is actually output.

As shown in (5) of FIG. 10, the AND operator 54 performs AND operation on the output results of the bit width shifting circuit 52 and the setting data shifting circuit 53 and completes table generation processing that relates to the set of setting data.

The operator 60 may, in the same manner as the operator 50, set the bit width to 3 and the shift position from the LSB to 9 for the set of setting data 2. Further, the operator 70 may perform operation for the set of setting data 3 and the operator 80 may perform operation for the set of setting data 4, respectively in a same manner as the operator 50, and therefore, descriptions for the settings of setting data 3 and 4 will be omitted. The OR operator 90 performs logical OR operation on the operational results of the operators 50, 60, 70 and 80 and outputs the result of the logical OR operation.

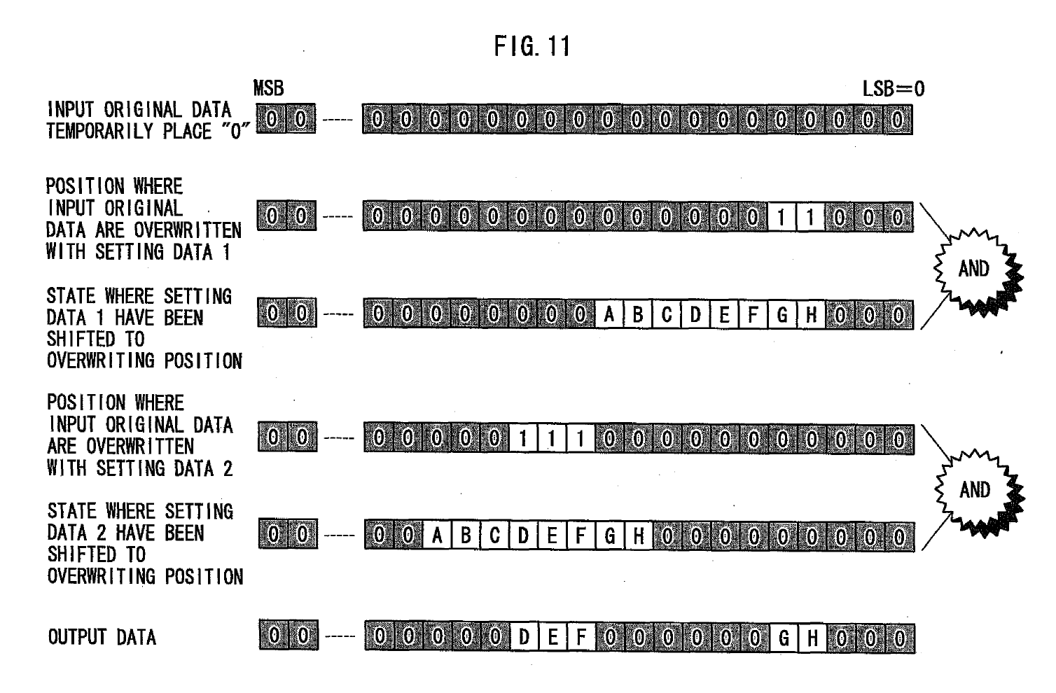

FIG. 11 is a diagram for describing the table data (output data) that is generated from the integrated sets of setting data 1 and 2. As shown in FIG. 11, GH, which is equal to 2 bits width of the set of setting data 1 that has been shifted 3 bits from the LSB, and DEF, which is equal to 3 bits width of the set of setting data 2 that has been shifted 9 bits from the LSB, are generated as the table data.

It will be noted that, similar to the first exemplary embodiment, the digital broadcast receiver may delimit the data in byte units when transferring setting data in byte units as many devices employs. Further, similar to the first exemplary embodiment, plural sets of setting data are eventually obtained as a result of OR operation by the OR operator 90 as described above.

As described above, even if the tuner 10 is not known, the digital broadcast receiver pertaining to the second exemplary embodiment of the present invention can, similar to the first exemplary embodiment, create table data that correspond to the tuner 10.

The above digital broadcast receiver handles, the related sets of setting data 1 and 2 of two or more elements as setting data of one element in terms of appearance, whereby the digital broadcast receiver can arbitrarily set a demarcation thereof as shown in FIG. 8.

Thus, for example, in a case where allocation of a swallow counter and a program counter of PLL setting data differs per tuner 10, it becomes possible to accommodate this. Further, it becomes possible to also accommodate a case where the numbers of bits in selection of a VCO itself in VCO selection and selection of a sub-band thereof differ per tuner 10.

Further, for these elements to be grouped, the number of bits that is necessary when these elements are grouped is roughly fixed, and therefore, there is also the advantage that the operation can be accomplished with a small circuit than considering the maximum widths that are individually assumed for each of the elements.

[Auto Channel Detection]

Next, a method of detecting channels using the table data that has been generated in the first or second exemplary embodiment will be described. It will be noted that the same reference numerals will be given to parts that are the same as the parts mentioned above and repetition of descriptions thereof are omitted, and that the points that are different will be mainly described.

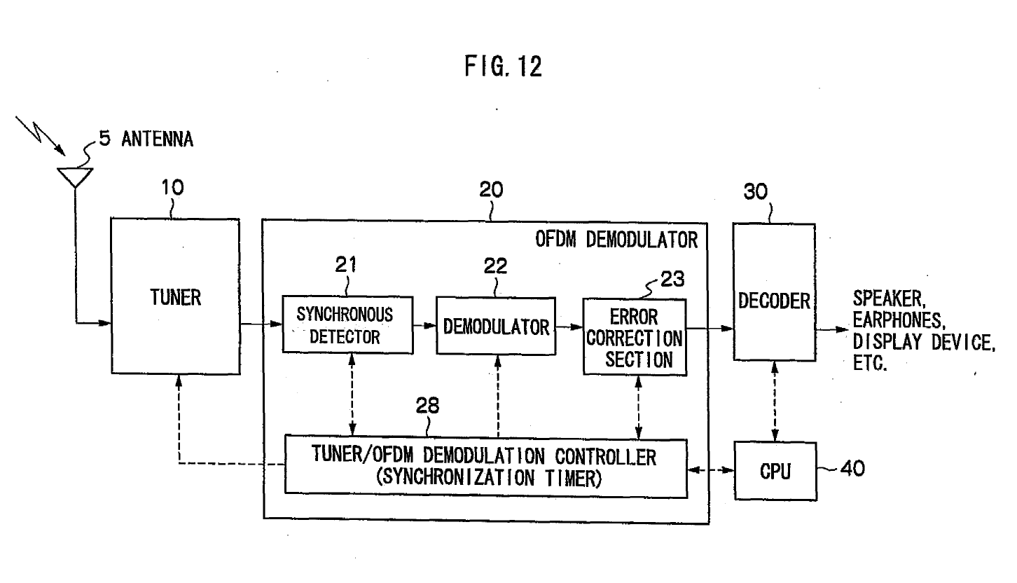

FIG. 12 is a diagram showing the configuration of a digital broadcast receiver. The OFDM demodulator 20 includes a tuner/OFDM demodulation controller 28. The tuner/OFDM demodulation controller 28 includes a synchronization timer.

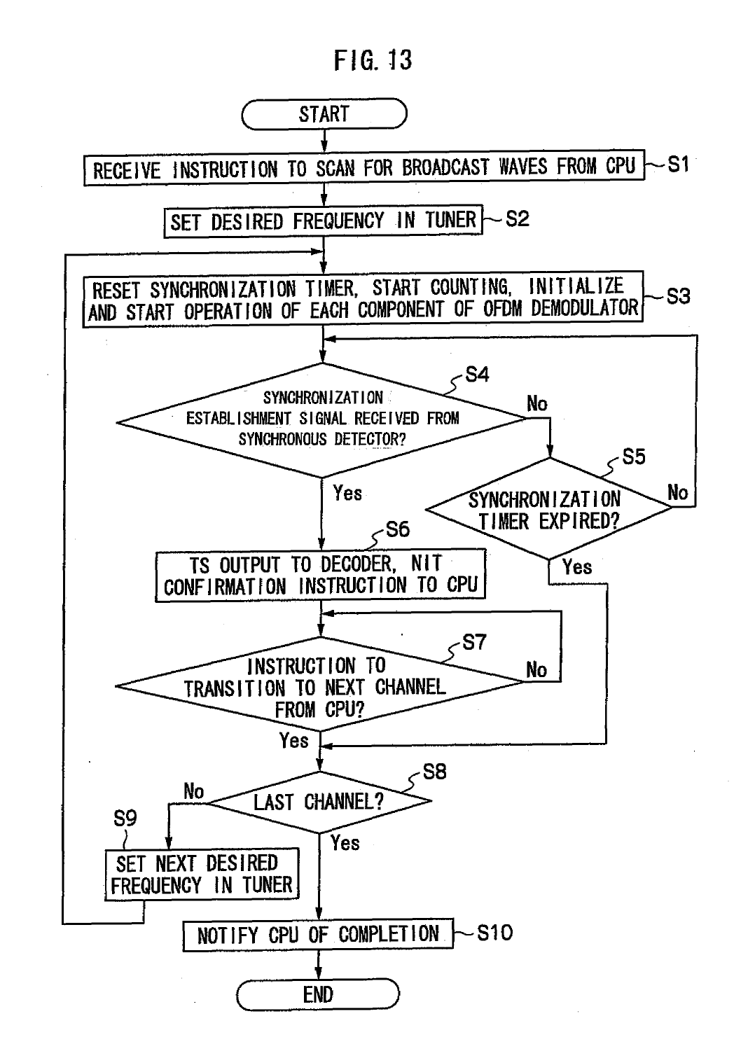

FIG. 13 is a flowchart showing a first channel detection routine.

The tuner/OFDM demodulation controller 28 receives a broadcast wave scanning start/end instruction from the CPU 40 (step S1) and uses the table data that has been generated by the first or second exemplary embodiment to perform synchronization control to a predetermined frequency with respect to the tuner 10 (step S2).

The tuner/OFDM demodulation controller 28 controls initialization of the synchronous detector 21, the demodulator 22 and the error correction section 23 at the point in time when the synchronization of the tuner 10 to the predetermined frequency is completed and causes these components to start operating. Further, the tuner/OFDM demodulation controller 28 resets an unillustrated synchronization timer section inside and starts counting (step S3).

The tuner/OFDM demodulation controller 28 determines whether or not it has received the synchronization establishment signal from the synchronous detector 21 (step S4). If the determination is negative (NO), the tuner/OFDM demodulation controller 28 determines whether or not the synchronization timer section has expired (step S5). If the synchronization timer section has not expired, the routine returns to step S4. When the tuner/OFDM demodulation controller 28 has received the synchronization establishment signal from the synchronous detector 21 (i.e., the determination of S4 is affirmative), the tuner/OFDM demodulation controller 28 judges that broadcasting is being performed on a channel of a predetermined frequency band and proceeds to step S6.

The tuner/OFDM demodulation controller 28 causes the signal that has been demodulated/decoded to be outputted from the OFDM demodulator 20 to the decoder 30 and notifies the CPU 40 that a broadcast parameter is being detected by the decoder 26 (step S6). Alternately, the CPU 40 itself may perform detection of the broadcast parameter.

The CPU 40 stands by until it judges that extraction of the broadcast parameter of that channel has been completed or that extraction is impossible, and instructs transition to the next channel at the point in time when it has judged that extraction has been completed or that extraction is impossible (step S7). If the channel is not the last channel (step S8), the tuner/OFDM demodulation controller 28 uses the table data to perform transition to the next channel with respect to the tuner 10 (step S9) and repeats the procedure of step S3 to step S7. If the channel is the last channel, the tuner/OFDM demodulation controller 28 notifies the CPU 40 of completion of the processing (step S10).

Further, when the tuner/OFDM demodulation controller 28 does not receive the synchronization establishment signal from the synchronous detector 21 (a negative determination in step S4) and the synchronization timer has expired (an affirmative determination in step S5), the tuner/OFDM demodulation controller 28 judges that broadcasting is not being performed on that channel, and if the channel is not the last channel (a determination of NO in step S8), the tuner/OFDM demodulation controller 28 performs transition to the next channel (step S9) and repeats steps S3 to S7.

It will be noted that the tuner/OFDM demodulation controller 28 of the OFDM demodulator 20 can perform the following processing when it includes an error correction timer.

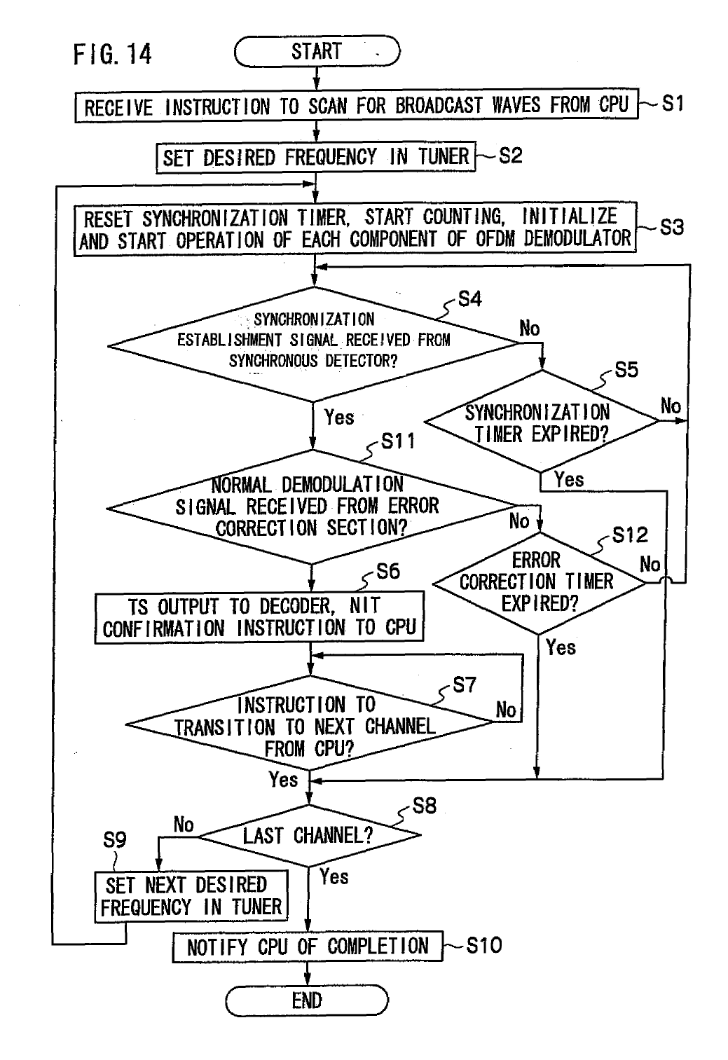

FIG. 14 is a flowchart showing a second channel detection routine. As shown in FIG. 14, when the determination in step S4 of FIG. 13 is affirmative (YES), the tuner/OFDM demodulation controller 28 may determine whether or not it has received a normal demodulation signal from the error correction section 23 (step S11). When the determination in step S11 is affirmative, the tuner/OFDM demodulation controller 28 proceeds to the aforementioned step S6, and when the determination is negative, the tuner/OFDM demodulation controller 28 proceeds to step S12. In step S12, the tuner/OFDM demodulation controller 28 determines whether or not the error correction timer has expired. If the error correction timer has expired, the tuner/OFDM demodulation controller 28 proceeds to step S8, and if the error correction timer has not expired, the tuner/OFDM demodulation controller 28 returns to step S4.

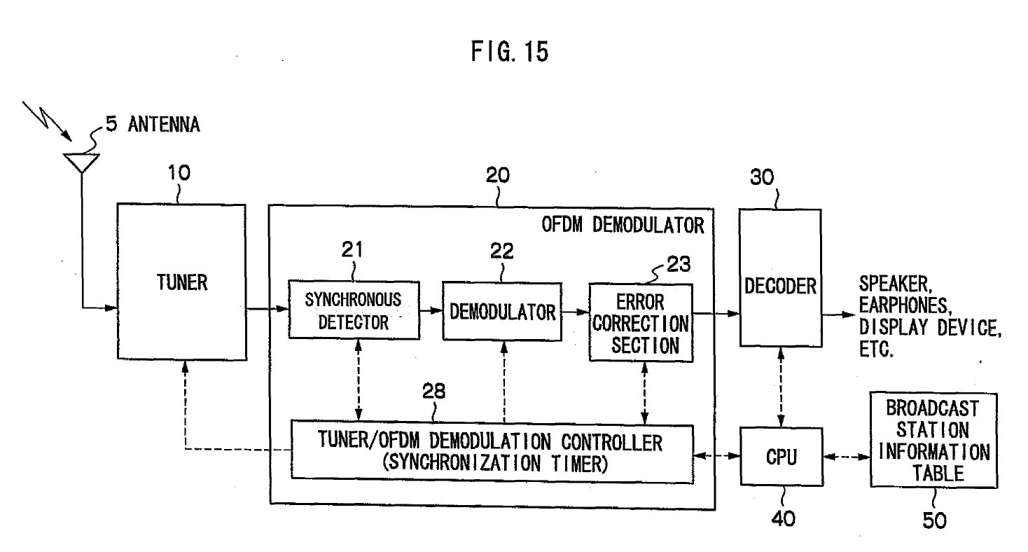

Further, the digital broadcast receiver may also include a broadcast station information table. FIG. 15 is a diagram showing a configuration of a digital broadcast receiver that includes a broadcast station information table 50. The broadcast station information table 50 shows corresponding relationships between broadcast stations and channel frequencies. In this case, the tuner/OFDM demodulation controller 28 of the OFDM demodulator 20 can perform the following processing.

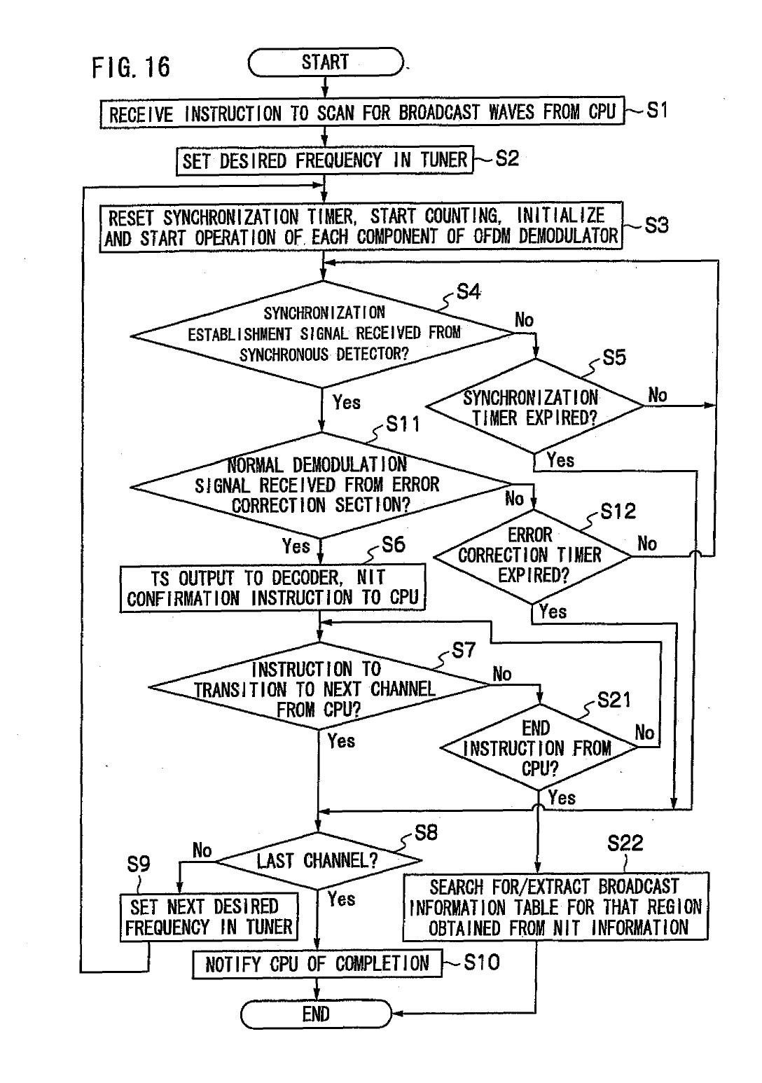

FIG. 16 is a flowchart showing a third channel detection routine. As shown in FIG. 16, if the determination in step S7 of FIG. 14 is negative, the tuner/OFDM demodulation controller 28 determines whether or not there is an end instruction from the CPU 40 (step S21). If the determination in step S21 is negative, the tuner/OFDM demodulation controller 28 returns to step S7. Further, when the determination in step S21 is affirmative, the tuner/OFDM demodulation controller 28 searches/extracts the broadcast station information table 50 of that region obtained from NIT information and ends processing.

Thus, when the CPU 40 has instructed discontinuation of channel scanning, channels are set using the broadcast station information table 50.

It will be noted that the present invention is not limited to the aforementioned exemplary embodiments and is also applicable to being designed and changed within the scope of the claims.

For example, the present invention is also applicable to a device that cannot rewrite table data by an external memory or software and in which it is necessary to have specific table data inside.

The present invention is useful for a device in which it is necessary to autonomously perform scanning of digital broadcasts and the like in applications that currently exist.

According to aspects of the present invention, the table data generation device and method generate table data for the setting data of the receiver by shifting the specified bit width of the setting data by the specified number of shifts. Thereby, it becomes unnecessary to prepare many sets of setting data in advance in order to set the receiver, and costs can be reduced.

According to the aspects, the table data generation device and method can generate table data also for setting data that have been generated inside the table data generation device or for setting data that has been generated in an external device that is different from the table data generation device.

Even when there are plural sets of setting data, the table data generation device and method can generate table data using each of the sets of setting data of the receiver by shifting the specified bit width of the setting data by the specified number of shifts.

Further, the table data generation device and method can use plural associated elements as one set of setting data and, for each of the elements of that setting data, regard and process, as one set, setting data including each of the associated elements by shifting the specified bit width by the specified number of shifts. Thereby, processing with a small circuit becomes possible and costs can be reduced.

What is claimed is:

1. A table data generation device comprising:
a setting data storage section that stores setting data of a receiver for receiving broadcast waves;
a bit width specification section that specifies a bit width from a reference position of the setting data;
a number-of-shifts specification section that specifies a number of shifts of the setting data; and
a table data generator that generates table data for the setting data by shifting the specified bit width of the setting data by the specified number of shifts.

2. The table data generation device of claim 1, wherein the setting data storage section stores setting data that has been generated inside the table data generation device or setting data that has been generated by an external device which is different from the table data generation device.

3. The table data generation device of claim 1, wherein the setting data storage section stores a plurality of sets of the setting data, and the table data generator generates table data for each of the sets of setting data by shifting the specified bit width by the specified number of shifts.

4. The table data generation device of claim 1, wherein the table data generator uses a plurality of associated elements as one set of setting data, and generates table data for each of the associated elements by shifting the specified bit width by the specified number of shifts.

5. A table data generation method comprising:
storing setting data of a receiver for receiving broadcast waves;
specifying a bit width from a reference position of the setting data and specifying a number of shifts of the setting data; and
generating table data for the setting data by reading the setting data and shifting the specified bit width of the setting data by the specified number of shifts.

6. The table data generation method of claim 5, wherein the method is executed in a device that comprises a storage section that stores setting data, and the stored setting data is generated inside the device or by an external device which is different from the device.

7. The table data generation method of claim 5, wherein the storing comprises storing a plurality of sets of the setting data, and the generating comprises generating table data for each of the sets of the setting data by shifting the specified bit width by the specified number of shifts.

8. The table data generation method of claim 5, wherein the generating comprises using a plurality of associated elements as one set of setting data, and generating table data for each of the associated elements by shifting the specified bit width by the specified number of shifts.
